(19) United States
(12) Patent Application Publication
(10) Pub. No.: US 2006/0059124 A1
(43) Pub. Date: Mar. 16, 2006

(54) Central access to remotely located information

(76) Inventor: Sudhir Krishna S, Bangalore (IN)

Correspondence Address: FISH & RICHARDSON, P.C., PO BOX 1022, MINNEAPOLIS, MN, 55440-1022, US

(21) Appl. No.: 10/942,177

(22) Filed: Sep. 16, 2004

(51) Int. Cl. G06F 17/30

(52) U.S. Cl. 707/3

(57) ABSTRACT

This document describes systems and methods for finding and accessing remotely stored information. In one aspect, a computer-implemented registry system for allowing a computer user to determine the location of an information item is provided. The registry system includes a record reception module. The record reception module receives a record that includes location information and one or more attributes of a stored information item. The record reception module also stores the record in a record repository. The record is generated at a site at which the corresponding stored information item is stored. The registry system also includes a request management module. The request management module receives from a terminal a request for information that includes one or more attributes of a requested information item. The request management module also compares the request with records stored in the record repository. The request management module also selects one or more matching records corresponding to the one or more attributes of the request. The registry system also includes a response providing module. The response providing module provides to the terminal a location identifier corresponding to location information of one or more matching information items that correspond to the one or more matching records.

### TECHNICAL FIELD

This document relates to finding and accessing remotely stored information.

### BACKGROUND

Many enterprises operate from multiple sites in various parts of the world. Often, information items, such as documents, presentations, drawings, or other electronic files, are stored on computers located at each site. Many users located at the various sites may have reason to access such information items located at other sites. For example, suppose a division of an enterprise is engaged in a project to create a new product. Further suppose that the division's members are dispersed across multiple sites. In such a project, members may wish to access certain information items collaboratively. Examples include engineers from different sites working on a design specification, marketing team members using presentation slides stored in a common repository, sales force members gathering promotional materials, and so on. Many other situations call for multi-site collaboration.

Some enterprises may accommodate multi-site collaboration by replicating all information items that may be accessed by users and storing a copy of each information item at each site. As enterprises grow larger, and the number of information items that must be replicated grows larger, replication may become cumbersome. Transmitting a large volume of information items consumes a large amount of bandwidth. In many cases, such as when sites within an enterprise span multiple continents, available inter-site bandwidth may be limited. In some cases, such bandwidth limitations may be prohibitive. Additionally, the replication process may take a substantial amount of time. During such time, a user may modify an information item being replicated. The system may not be able to account for the recent modification and may transmit the old information item to the other sites. Thus, a user located at one of the other sites wishing to access that information item may not be able to access the most recent version. This could result in work being lost.

Some enterprises may accommodate multi-site collaboration by maintaining only one copy of an information item. The information items may be dispersed across the multiple sites of the enterprise. A user wishing to access an information item may submit a request for the information item to each of the enterprise's sites. If the request is precise, multiple information items may be transmitted, consuming valuable bandwidth.

### SUMMARY

This document describes systems and methods for finding and accessing remotely stored information. In one aspect, a computer-implemented registry system for allowing a computer user to determine the location of an information item is provided. The registry system includes a record reception module. The record reception module receives a record that includes location information and one or more attributes of a stored information item. The record reception module also stores the record in a record repository. The record is generated at a site at which the corresponding stored information item is stored. The registry system also includes a request management module. The request management module receives from a terminal a request for information that includes one or more attributes of a requested information item. The request management module also compares the request with records stored in the record repository. The request management module also selects one or more matching records corresponding to the one or more attributes of the request. The registry system also includes a response providing module. The response providing module provides to the terminal a location identifier corresponding to location information of one or more matching information items that correspond to the one or more matching records.

In some implementations, the record reception module receives records without having first solicited the records. In some implementations, the record reception module is configured to receive a copy of records stored in one or more computers located at one or more remote sites. The request management module may transmit the request to a remote search engine and receive one or more matching records corresponding to the one or more attributes of the request. In some implementations, the registry system includes a record retrieving module. The record retrieving module retrieves records and causes the records to be transmitted to the record reception module. The location identifier may include a hyperlink for each of the matching information items. The terminal may be located remotely from the request management module.

In a second aspect, a computer-implemented retrieval system for allowing a computer user to determine the location of an information item is provided. The retrieval system includes a request generator. The request generator generates a request that includes one or more attributes of a requested information item. The retrieval system also includes a request transmitting module. The request transmitting module causes the request to be transmitted to a registry module. The registry module compares the request with records that include location information and one or more attributes of stored information items and selects one or more matching records that correspond to the one or more attributes of the request. Each record is generated at a site at which the corresponding stored information item is stored. The retrieval system also includes a response receiving module. The response receiving module receives a location identifier corresponding to location information of matching information items from the registry module. Each matching information item corresponds to a matching record.

In some embodiments, the retrieval system includes a record pushing module.

The record pushing module causes records to be transmitted to the registry module without the registry module having first solicited the records. The retrieval system may also include a record gathering module. The record gathering module causes records to be transmitted to the registry module in response to solicitations for the records from the registry module. The retrieval system may also include an information item retrieving module. The information retrieving module includes a request module. The request module generate an information item request to retrieve a first matching information item located at a first remote site. The information retrieving module also includes a connector. The connector receives and decompresses the first matching information item in a compressed format. In some implementations, the registry system includes registry module. In such implementations, the registry module receives records from a local record generating module. In such implementations, the registry module also receives copies of records stored in one or more computers located at one or more remote sites. In some implementations, the location identifier includes a hyperlink for each of the matching information items. In some implementations, the registry module is located remotely from the request transmitting module.

In a third aspect, a computer-implemented method for providing the location of an information item to a computer user comprising is provided. The method includes receiving a record that includes location information and one or more attributes of an stored information item. The record is generated at a site at which the corresponding stored information item is stored. The method also includes storing the record in a record repository. The method further includes receiving from a terminal a request for information including one or more attributes of a requested information item. The method also includes comparing the request with records stored in the record repository. The method also includes selecting one or more matching records corresponding to the one or more attributes of the request. The method also includes providing to the terminal a location identifier corresponding to location information of one or more matching information items that correspond to the one or more matching records.

In some implementations, the record is received unsolicited. In some implementations, the record is actively retrieved. The location identifier may include a hyperlink for each of the matching information items. The terminal from which the request is received may be located at a remote site. The method may also include receiving copies of records stored in one or more computers located at one or more remote sites. The method may also include transmitting the request to a remote search engine and receiving one or more matching records from the remote search engine.

In a fourth aspect, a computer-implemented method for retrieving the location of an information item from a registry is provided. The method includes generating a request having one or more attributes of a requested information item. The method also includes causing the request to be transmitted to a registry module. The registry module compares the request with records that include location information and one or more attributes of stored information items. Each record is generated at a site at which the corresponding stored information item is stored. The method also includes selecting one or more matching records that correspond to the one or more attributes of the request. The method also includes receiving a location identifier corresponding to location information of matching information items from the registry module. Each matching information item corresponds to a matching record.

In some implementations, the method includes causing records to be transmitted to the registry module without the registry module having first solicited the records. In some implementations, the method includes causing records to be transmitted to the registry module in response to solicitations for the records from the registry module. The location identifier may include a hyperlink for each of the matching information items. In some implementations, the method includes generating an information item request to retrieve a first matching information item located at a first remote site. In such implementations, the method also includes compressing the information item request into a compressed information item request. In such implementations, the method also includes causing the compressed information item request to be transmitted to a connector located at the first remote site. In such implementations, the method also includes receiving the first matching information item in a compressed format from the connector located at the first remote site. In such implementations, the method also includes decompressing the first matching information item. In such implementations, the method also includes providing the first matching information item to a user. The registry module may be located at a remote site. In some implementations, the method includes receiving copies of records stored in one or more computers located at one or more remote sites and storing the copies of records in the registry module.

Certain implementations may provide one or more of the following advantages. Computer users may be able to access the most up-to-date version of a desired information item. Records of an enterprise's information items may be maintained in an orderly fashion. In some implementations, a computer user may be able to access only the information item he or she desires. This may result in minimal bandwidth consumption. In certain implementations, the computer user may be able to access the desired information in a compressed format, again resulting in minimal bandwidth consumption. In some implementations, inter-site communication may be encrypted and decrypted to prevent unauthorized persons from accessing the potentially sensitive material being communicated during transmission.

The details of one or more implementations are set forth in the accompanying figures and the description below. Other features, objects, and advantages will be apparent from the description and figures, and from the claims.

### DESCRIPTION OF FIGURES

FIG. 1 is a flow diagram illustrating how an information item is stored in a registry, located by a remote system, and accessed.

FIG. 2 is a block diagram of a communication system with a central registry and two remote systems.

FIG. 3 is an exemplary registration prompt.

FIG. 4 is an exemplary search request form.

FIG. 5 is a block diagram that provides a detailed view of information retrieval systems of two remote systems.

FIG. 6 is a flow chart illustrating how records are registered in a central registry.

FIGS. 7A-7B are a flow chart illustrating how users access information items stored in locations unknown to the users.

Like reference symbols in the various figures indicate like elements.

### DETAILED DESCRIPTION OF ILLUSTRATIVE IMPLEMENTATIONS

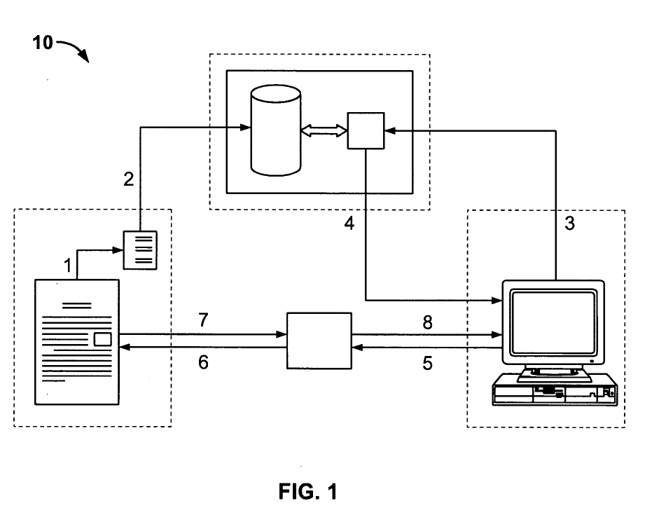

FIG. 1 is a flow diagram of an exemplary communication system 10 in which a computer user at one location can find and retrieve an information item by consulting a central registry. Attributes of each information item are gathered and formatted into a record (step 1), and the record is transmitted to the central registry (step 2).

Other records may also be stored in the central registry, corresponding to other information items, whether stored at the one location or at others. A computer user at a different location transmits a request for the location of a desired information item to the central registry (step 3). The central registry then searches the stored records and provides to the computer user the location of, or a description of, information items having matching attributes (step 4). The computer user determines which of the information items having matching attributes is the desired information item. The computer user then requests the desired information item (step 5) according to the location information provided by the central registry. The request is guided to the repository in which the desired information item is stored by routers and switches (step 6). The information item then travels back to the computer user (step 7), being guided by routers and switches (step 8).

Such a communication system 10 may allow computer users to access information items stored at remote sites without consuming prohibitive amounts of bandwidth. Information items may include any type of electronic file that a computer user may wish to access. Examples include word processing documents, presentations, drawings, and various other applications. Attributes of information items may include any characteristic that describes or identifies an information item. Examples of attributes include the information item name, the information item location, the information item size, when and by whom the information item was last modified, keywords, and categories.

Such a communication system 10 may provide numerous advantages. Computer users may be able to access the most up-to-date version of a desired information item. Records of an enterprise's information items may be maintained in an orderly fashion. In some implementations, a computer user may be able to access only the information item he or she desires. This may result in minimal bandwidth consumption. In certain implementations, the computer user may be able to access the desired information in a compressed format, again resulting in minimal bandwidth consumption. In some implementations, inter-site communication may be encrypted and decrypted to prevent unauthorized persons from accessing the potentially sensitive material being communicated during transmission.

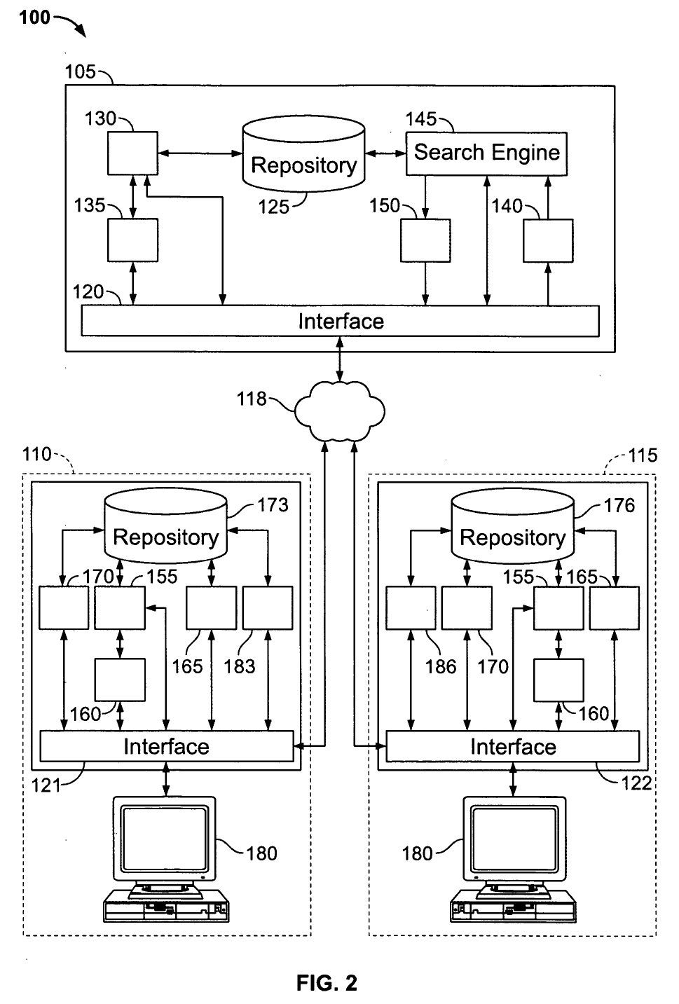

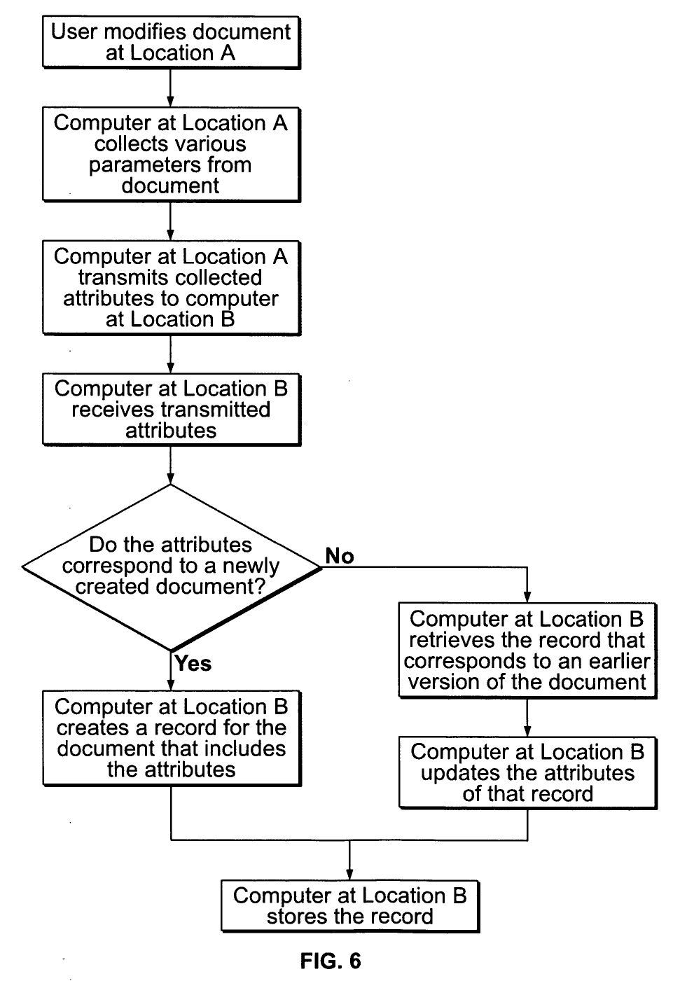

FIG. 2 is a block diagram of a communication system 100 similar to that of FIG. 1. The communication system 100 may include a central registry 105 and two remote systems 110, 115. The central registry 105 may be located a substantial distance from either or both of the two remote systems 110, 115. The central registry 105 may communicate with either or both of the remote systems 110, 115 through a WAN 118, such as the Internet. The central registry 105 and the remote systems 110, 115 may communicate with the WAN 118 through respective interfaces 120, 121, 122. Each component of the central registry 105 may be linked, either directly or indirectly, with the interface 120, allowing components external to the central registry 105 to communicate with components internal to the central registry 105. Similarly, each component of the remote systems 110, 115 may be linked, either directly or indirectly, with the interface 120, allowing components external to the remote systems 110, 115 to communicate with components internal to the remote systems 110, 115. Communication between systems is discussed in greater detail in conjunction with FIG. 5.

Referring again to FIG. 2, the central registry 105 may include a repository 125 that stores records of various attributes of information items stored in other repositories. The other repositories may be centrally or remotely located. The records may include such attributes as the information item name, the information item location, the information item size, when and by whom the information item was last modified, keywords, categories, and other suitable attributes. Administrators of the communication system 100 may designate attributes specific to an enterprise using the communications system 100. For example, information items associated with a particular project may be assigned a project number, which may be included in the records.

The central registry 105 may include a record receiving module 130 for receiving and directing the various records to be stored in the repository 125. The record receiving module 130 may receive records in various ways. For example, the central repository 105 may include a record pulling module 135. The record pulling module 135 may transmit requests to each of the remote systems 110, 115 for records of the various information items stored on the respective remote systems 110, 115. The remote systems 110, 115 may respond to the request by providing records containing attributes of the various information items stored at the respective remote systems 110, 115 to the record pulling module 135. The record pulling module 135 may then provide the records received to the record receiving module 130, which may then direct the records to the repository 125 for storage. Administrators of the communication system 100 may determine, for example, when and how often the record pulling module 135 should retrieve records from the remote systems 110, 115. In some implementations, the record pulling module 135 may be triggered by a simple signal received directly or indirectly from one or both of the remote systems 110, 115. When the record pulling module 135 receives such signal, the record pulling module 135 may begin the process of retrieving records from the remote system 110, 115. Such signal may be generated when an information item is created or modified.

The central registry 105 may also include a system for allowing computer users of remote systems 110, 115 to search the repository 125, using attributes of the information items they are seeking as search terms. The system may include a request receiving module 140. The request receiving module 140 may be responsible for receiving requests from remote systems 110, 115, verifying that the requests are in the proper format, and transmitting the requests to a search engine 145. If the request is not in the proper format, the request receiving module 140 may be responsible for notifying the remote system 110, 115 from which the request was transmitted. The search engine 145 may be responsible for comparing the attributes contained in the request with the records stored in the repository 125. The search engine 145 may identify all records that include the attributes of the request. A response module 150 may be responsible for receiving the identified records from the search engine 145, formatting them into a response, and providing the response to the remote system 110, 115 from which the request was transmitted.

In some implementations, more sophisticated searching capabilities, such as full-text or fuzzy searching, may be provided. In such implementations, the searching mechanism may be distributed across the different remote systems 110, 115. For example, the search engine 145 of the central registry 105 may transfer a request to search engines 183, 186 located on the respective remote systems 110, 115. Each remote repository 173, 176 may contain records that correspond to the information items stored at the respective remote sites 110, 115. The remote search engines 183, 186 may respond by providing responsive records from the respective remote repositories 173, 176. The search engine 145 of the central registry 105 may combine the identified records from the remote systems 110, 115 and transmit them to the response module for formatting and transmission to the requesting remote system 110, 115.

Although the central registry 105 has been described as having seven distinct components-an interface 120, a record pulling module 135, a record receiving module 130, a repository 125, a search engine 145, a request receiving module 140, and a response module 150-the central registry 105 may be arranged in any appropriate manner. For example, two or more of the components could be combined, or additional components could be provided. In addition, the order of, and interrelationships between, the various components could be rearranged. As one example, the request receiving module 140 and the response module 150 may be combined into one component. Moreover, the search engine 145 may identify all records that include less than all of the attributes of the request. For example, the search engine 145 may identify all records that include at least one of the attributes of the request.

The remote systems 110, 115 may include a variety of components for communicating with the central registry 105 and with each other. For example, the remote systems 110, 115 may include a record gathering module 155. The record gathering module 155 may be responsible for gathering attributes from information items and formatting them into a record to be stored in the repository 125 at the central registry 105. The record gathering module 155 may gather attributes from information items on a periodic basis, as determined by an administrator of the communication system 100. The record gathering module 155 may limit the attributes it gathers to only those of information items that have been created or modified since the last time the record gathering module 155 gathered attributes.

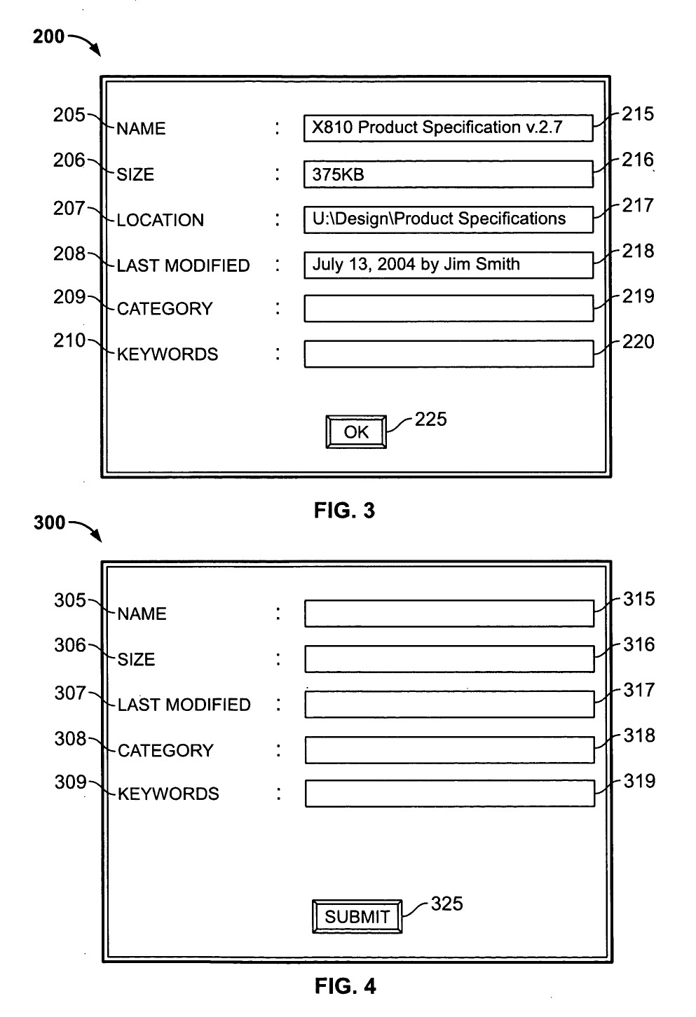

In some implementations, the record gathering module 155 may gather attributes from information items as soon as such information items are created or modified. In such implementations, the computer user may optionally be prompted to provide additional attributes, such as keywords, categories, and the like. Such prompt may occur when the computer user creates an information item, saves an information item, closes an information item, or at any other appropriate time. FIG. 3 shows an exemplary prompt and is discussed in greater detail below. Referring again to FIG. 2, in some implementations, the record gathering module 155 may provide records to the central registry 105. When the record pulling module 135 transmits a request for records to the remote systems 110, 115, the record gathering module 155 may be responsible for providing records to the record pulling module 135 in response.

In some implementations, the remote systems 110, 115 may include a record pushing module 160. The record pushing module 160 may be responsible for receiving records from a record gathering module 170 and transmitting them to the record receiving module 130 located at the central registry 105. The record pushing module 160 may receive only the records that have been created or modified since the last time the record pushing module 160 received records. The record pushing module 160 may transmit records to the record receiving module 130 as soon as such records are received from the record gathering module 155. In some implementations, the record pushing module 160 may push records to the record receiving module 130 on a periodic basis, as determined by an administrator of the communication system 100. For example, the record pushing module 160 may be programmed to push records to the record receiving module 130 every fifteen minutes, every hour, every day, or according to any other appropriate schedule.

A system in which a remote system 110, 115 transmits records to the central registry 105 without being requested to do so by the central registry 105 may be called a push system. A system in which the central registry 105 requests that one or more of the remote systems 110, 115 transmit records to the central registry 105 before the remote systems 110, 115 so transmit may be called a pull system. The communication system 100 may operate exclusively as a push system, with each remote system 110, 115 pushing records to the central registry 105. The communication system 100 may operate exclusively as a pull system, with the central registry 105 pulling records from each remote system 110, 115. In some implementations, the communication system 100 may operate as a combination of push systems and pull systems. For example, the central registry 105 may pull records from one remote system 110 while the other remote system 115 pushes records to the central registry 105. In another example of a combination push-pull system, the central registry 105 may pull some of the records from a remote system 110 while that remote system 110 may push other records to the central registry 105.

The remote systems 110, 115 may also allow computer users to search through records stored at the central registry 105 by including a request engine 165. The request engine 165 may be responsible for generating search requests, based on input from a computer user, and transmitting those requests to the request receiving module 140 of the central registry 105. The computer user may enter attributes of an information item he or she is seeking in a request form. For example, a user may enter the name of an information item he or she wishes to access. The user may also enter that Jane Smith was the last person to have modified the information item. The request engine 165 would generate a request that included the information item's name and that Jane Smith last modified the information item. The request engine 165 may then transmit the request to the central registry 105.

Referring again to FIG. 2, the request module 165 may receive the attributes input by the user and formulate such attributes into a request to be transmitted to the request receiving module 140. The request engine 165 may then transmit the request to the request receiving module 140. The request receiving module 140 may trigger the search engine 145 to search the repository 125 at the central registry 105, and the search engine 125 may provide records that include all the attributes of the request to the response module 150. The response module 150 may then transmit the identified records to the request engine 165.

The request engine 165 may be responsible for receiving the identified records from the response module 150, formatting the records for display, and transmitting them to a computer 180 for display to the computer user who made the request. The request engine 165 may designate any desired attributes of the identified records for display. For example, all attributes of the identified records may be displayed.

In some implementations, a computer user may only be interested in the location of a particular information item. In such implementations, the request engine 165 may designate that only the information item's location be acquired. In such implementations, the user may desire to view attributes in addition to the information item's location. For example, if multiple records are identified, the computer user may wish to view attributes, such as information item name and description, and when and by whom the information item was last modified, to distinguish the desired information item from the other information items.

In some implementations, when a computer user desires an information item's location, the request engine 165 may designate that a hyperlink to that information item be displayed. In such implementations, the computer user may access the information item by clicking on the hyperlink.

In some implementations, the computer user may wish to view attributes other than the location of an information item. For example, a computer user may wish to gather a list of people who have authored an information item that is stored in a particular folder. In such case, the computer user may enter the location of the folder in the request. In response, the search engine 145 would identify the records of all information items stored in that folder. The request engine 165 would then be able to designate the authors corresponding to the identified records for display. Other queries on information held in the repository 125 may be performed.

The remote systems 110, 115 may include an information item retrieval subsystem 170. The information item retrieval system 170 may be responsible for responding to requests for information items stored in the repositories 173, 176 of the respective remote system 110, 115. Such requests may come from within a remote system 110 or from a source outside of the remote system 110, such as the other remote system 115. The information item retrieval subsystem 170 is discussed in greater detail in conjunction with FIG. 5.

Referring again to FIG. 2, although the remote systems 110, 115 have been described as having six distinct components—an interface 121, 122, an information item retrieval subsystem 170, a repository 173, 176, a record gathering module 155, a record pushing module 160, and a request engine 165—the remote systems 110, 115 may be arranged in any appropriate manner. For example, two or more of the components could be combined, or additional components could be provided. In addition, the order of, and interrelationships between, the various components could be rearranged. As one example, the record gathering module 155 and the record pushing module 160 may be combined into one component. Additionally, each remote system 110, 115 could contain different components, or differently situated components, from the other remote systems 110, 115. In some implementations, the request engine 165 may be multiple components. In such implementations, a request engine may be responsible for generating the requests and transmitting them to the request receiving module 140, and a response receiving module may be responsible for receiving records from the response module 150 and designating them for display.

Although the communication system 100 has been described as having four distinct components—a central registry 105, two remote systems 110, 115, and a WAN 118—the communication system 100 may be arranged in any appropriate manner. For example, the communication system 100 may include more than two remote systems. Some of the remote systems may be connected together through, for example, a LAN. The communication system 100 may include a central system for allowing computer users at the central location to search the central registry 105. The central system may include the same components, or components having the same or similar functionality, as either or both of the remote systems 110, 115. The central system may communicate with the central registry 105 through, for example, a LAN.

Also, in one implementation, the functionality of the communication system 100 may be allocated evenly across the entire system, rather than having one dedicated central location and multiple remote locations. Specifically, each location may be provided with a repository 125 so that all or most searching of records can occur locally. The various locations may coordinate to replicate records across all the locations—a replication process that can require orders of magnitude less bandwidth than replication of the entire group of full-size information items. Each location may return a common set of search results so that all information items look the same to the user regardless of their location. Also, an indicator such as an icon may be placed next to “local” items in the search result to inform users that the information item is available locally. Additional information about local information items may also be provided, such as a thumbnail of the information item. This symmetric arrangement, whereby replicated copies of records are kept at multiple or all locations, increases bandwidth requirements slightly for the replication process, but decreases the bandwidth requirements for searching because the searching can be conducted locally.

FIG. 3 is an example of a prompt 200 that a computer user may encounter when opening, saving, or closing an information item, or at any other appropriate time. The prompt 200 may include several attribute types 205-210. As shown, the attribute types 205-210 include the information item's name 205, the information item's size 206, the information item's location 207, when and by whom the information item was last modified 208, the information item's category 209, and any key words 210 associated with the information item. The prompt 200 may include fields 215-220 that correspond to the attribute types 205-210. As shown, the name field 215, the size field 216, the location field 217, and the last modified field 218 contain information. This may correspond to implementations in which users create and save information items through separate means, such as through different prompts. In such implementations, the computer on which the information item is running may automatically gather the information shown in fields 215-218 in FIG. 3. In such implementations, the prompt 200 may appear as the computer user closes the information item, giving the computer user the option to enter information in the category field 219 and the keywords field 220. When the computer user determines that the fields 215-220 are sufficiently completed, he or she may actuate the “OK” button 225. Actuating the “OK” button 225 may initiate the process of storing a record for the information item in the repository at the central registry as described in conjunction with FIG. 1.

In some implementations, the prompt 200 may include a greater or lesser number of attribute types 205-210 and a greater or lesser number of corresponding fields. For example, in some implementations, the prompt 200 may appear as a computer user creates an information item. In such implementations, the attribute types provided in the prompt 200 may include the name the user wishes to assign to the information item, the location at which the user wishes to store the information item, any categories or keywords the user wishes to associate with the information item, or any other appropriate attribute types. In such implementations, the user may enter information into one or more of the corresponding fields and actuate the “OK” button 225 to begin the registration process. In another example, the prompt 200 may appear in connection with a user saving an information item. In such implementations, some attribute types may be automatically entered, such as the size of the information item and when and by whom the information item was last modified. In such implementations, the user may enter information in the fields corresponding to other attribute types, such as the name of the information item, the location of the information item, any categories or keywords of the information item, and any other appropriate attribute type. In such implementations, the user may enter such information and then actuate the “OK” button 225 to begin the registration process. In some implementations, one or more of the user-defined fields may be a required field. A user's failure to enter information in required fields may result in a prompt notifying the user of such failure.

In some implementations, certain applications, such as Microsoft Word may automatically provide the requisite attributes. In such implementations, the user is not prompted with the prompt 200.

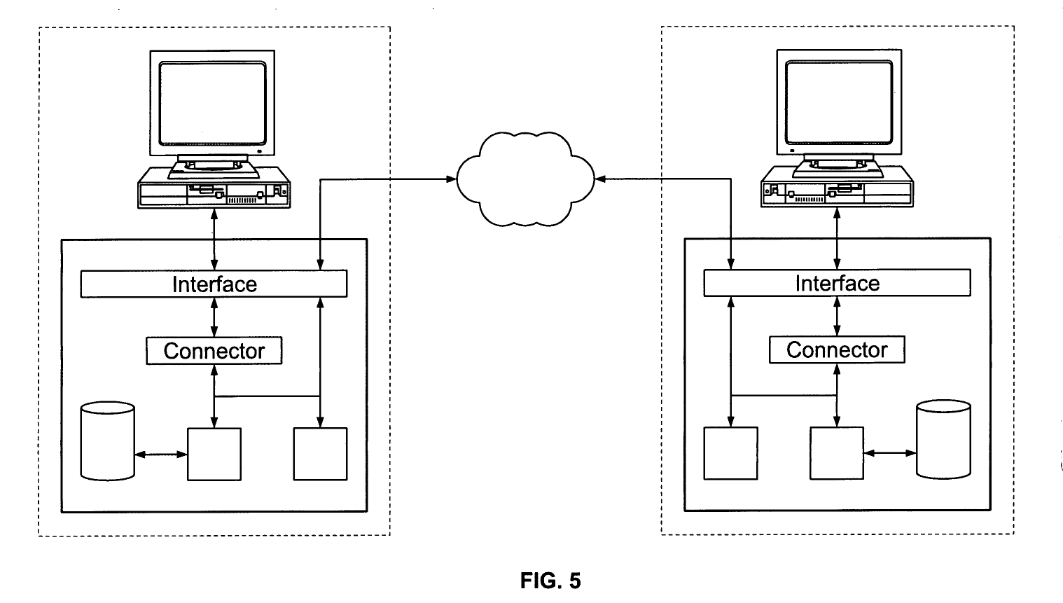

FIG. 4 is an exemplary request form 300 that a computer user may complete to initiate a search of the central registry. Like in FIG. 3, the request form 300 of FIG. 4 includes several attribute types: the name of an information item 305, the size of an information item 306, when and by whom the information item was last modified 307, any category associated with the information item 308, and any keywords associated with the information item 309. For each of the attribute types 305-309, there is a corresponding input field 315-319. A user may enter information related to the information item he or she desires to access in one or more of the input fields 315-319. Then the user may actuate the “SUBMIT” button 325 to initiate the searching process. The user may also be given the ability to search in more flexible manners, such as by complex Boolean entries or by natural language queries.

In some implementations, one or more of the input fields 315-319 may be required fields. In such implementations, actuation of the “SUBMIT” button 325 may trigger an error prompt to appear that instructs the user to enter information in the required field. The request form 300 of FIG. 4 may be desirable for users who wish to access an information item and are seeking that information item's location. In some implementations, the user will know the location of, for example, a folder containing information items and will wish to know the names of the information items stored within that folder. In such implementations, the request form would include the information item's location as an attribute type, allowing the user to enter the location and actuate the “SUBMIT” button to initiate the searching process.

FIG. 5 is a modified block diagram of the two remote systems 110, 115 of the communication system shown in FIG. 2. Referring to FIG. 5, the information item retrieval subsystems 170 are shown in greater detail. The information item retrieval subsystems 170 may be responsible for generating and transmitting requests for information items and for responding to requests by retrieving requested information items. The information item retrieval subsystems 170 may include request generating modules 405, 407. The request generating modules 405, 407 may be responsible for generating requests for information items based on input from computer users. The request generating modules 405, 407 may also be responsible for determining which component may be capable of responding to the request. The information item retrieval subsystems 170 may include response modules 410, 412. The response modules 410, 412 may be responsible for providing information items to computer users or remote systems in response to requests.

In some implementations, a user at remote system 110 may request an information item stored at remote system 110. The request generating module 405 may generate the request and retrieve the information item from the repository 173. The request generating module 405 may then transmit the information item to the response module 410, which may provide the information item to the computer user. In other implementations, the request generating module 405 may generate the request and transmit it to the response module 410. In such implementations, the response module 410 may retrieve the information item from the repository 173 and provide the information item to the computer user.

In some implementations, a user at remote system 110 may request an information item stored at remote system 115. The request generating module 405 may generate the request and transmit the request to a connector 415. The connector 415 may communicate with a corresponding connector 417 at remote system 115. The connectors 415, 417 may allow for communication between remote system 110 and remote system 115 in a protocol that uses less bandwidth. One example of such a protocol is Simple Object Access Protocol (SOAP), which uses Hypertext Transfer Protocol (HTTP) and Extensible Markup Language (XML) as the mechanisms of information exchange. This communication may also be secure to prevent unauthorized persons from accessing the potentially sensitive material being communicated.

Thus, when the connector 415 receives the request from the request generating module 405, the connector 415 may compress the request into a format that consumes less bandwidth. The connector 415 may convert the request into a format that is secure. Then the connector 415 may transmit the modified request to the corresponding connector 417 through a WAN 118. The connector 417 may convert the modified request into a format that remote system 115 can understand (i.e., decompressing and/or decrypting the modified request) and transmit the converted request to the response module 412. The response module 412 may retrieve the requested information item and transmit it to the connector 417. The connector 417 may then compress and/or encrypt the requested information item and transmit the compressed/decrypted information item to connector 415 through the WAN 118. The connector 415 may decompress and/or decrypt the information item and provide it to the response module 410, which may provide the requested information item to the user.

Although the information item retrieval subsystems 170 have been described as having three distinct components—a request generating module 405, 407, a response module 410, 412, and a connector 415, 417-the information item retrieval subsystems may be arranged in any appropriate manner. For example, two or more of the components could be combined, or additional components could be provided. In addition, the order of, and interrelationships between, the various components could be rearranged. As one example, the request generating modules 405, 407 and the response modules 410, 412 may be combined into one component.

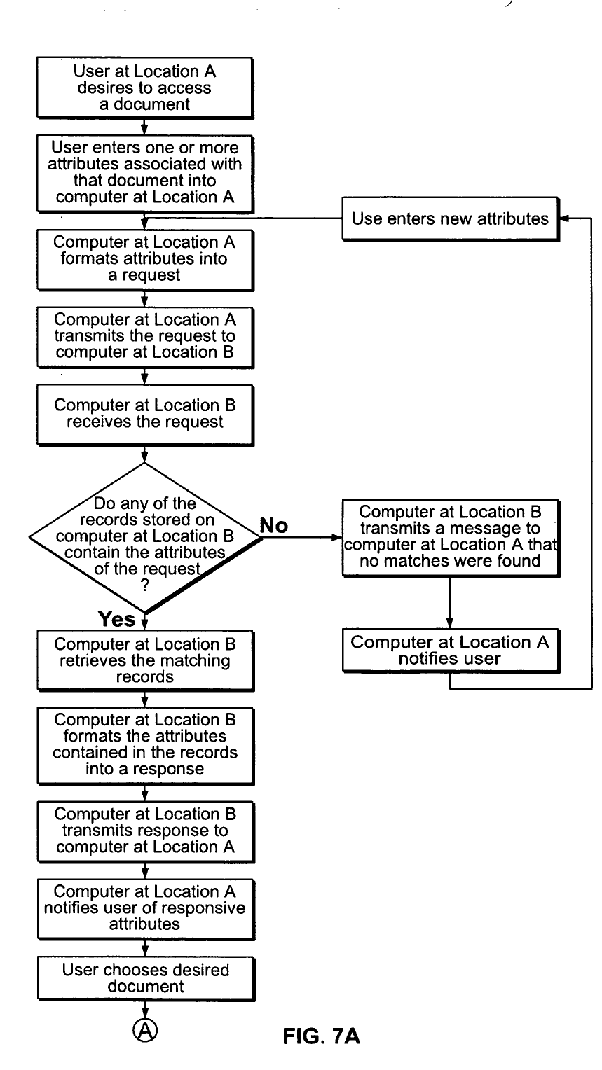

FIG. 6 is a flow chart illustrating how records are registered in a central registry (500). A user may create or modify an information item at Location A (505). The computer at Location A may collect various parameters from the information item (510). The user may enter additional parameters (515). The computer at Location A may formulate the parameters into a record (520). The computer at Location A may transmit the record to a computer at Location B (525). The computer at Location B may determine whether the record corresponds to a newly created information item (530). If so, the computer at Location B stores the record (535). If the record corresponds to an information item that was previously created, but recently modified, the computer at Location B discards the old record corresponding to that information item (540) and stores the new record (535).

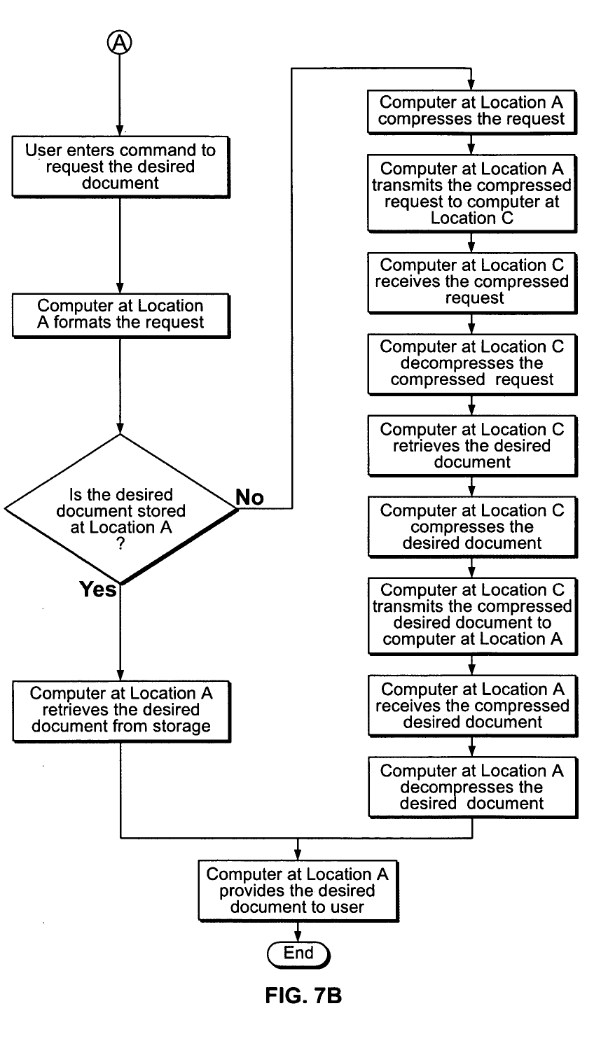

FIGS. 7A-7B are a flow chart illustrating how a user may access an information item stored in a location that is unknown to the user (600). FIG. 7A illustrates how the user may determine the location of the desired information item, and FIG. 7B illustrates how the user may access the desired information item.

Referring to FIG. 7A, a user may enter one or more attributes associated with a desired information item into a computer at Location A (602). The computer at Location A may format those attributes into a request (604). The computer at Location A may transmit that request to a computer at Location B (606), which may include a central registry. The computer at Location B may determine whether any of the records stored in the computer at Location B include the attributes of the request (608). If not, the computer at Location B may transmit a message to the computer at Location A indicating that no matches were found (610). The computer at Location A may notify the user (612). The user may enter new attributes (614), beginning the search process again. If the computer at Location B determines that one or more of the records stored in the computer at Location B include the attributes of the request, the computer at Location B may retrieve the matching records (616). The computer at Location B may format those records into a response (618). The computer at Location B may transmit that response to the computer at Location A (620). The computer at Location A may display the matching records to the user (622). The user may then select the desired information item from among the matching records (624).

Referring to FIG. 7B, the user may enter a command to request the desired information item (626). Such command may include clicking on a hyperlink. The computer at Location A may format the request (628). The computer at Location A may determine whether the desired information item is stored at Location A (630). If so, the computer at Location A may retrieve the desired information item from storage (632) and provide the desired information item to the user (634). If the desired information item is stored somewhere other than at Location A, such as, for example, Location C, the computer at Location A may compress the request (636). The computer at Location A may also encrypt the request (638). Whether the computer compresses first and encrypts second or encrypts first and compresses second is unimportant.

The computer at Location A may then transmit the compressed, encrypted request to a computer at Location C (640). The computer at Location C may decrypt the request (642). The computer may also decompress the request (644). Whether the computer decrypts first and decompresses second or decompresses first and decrypts second is unimportant. The computer at Location C may retrieve the desired information item (646). The computer at Location C may compress the desired information item (648). The computer at Location C may also encrypt the desired information item (650). Again, whether the computer compresses first and encrypts second or encrypts first and compresses second is unimportant.

The computer at Location C may transmit the compressed, encrypted desired information item to the computer at Location A (652). The computer at Location A may decrypt (654) and decompress the desired information item (656). Again, whether the computer decrypts first and decompresses second or decompresses first and decrypts second is unimportant. The computer at Location A may then provide the desired information item to the user (634).

As used in this document, the term “computer” means a device, or multiple devices working together, that accepts information (in the form of digitalized data) and manipulates it for some result based on a program or sequence of instructions on how the data is to be processed. A computer may also include the means for storing data for some necessary duration.

As used in this document, the term “terminal” means any device that allows a computer user to send a command to a remotely located computer. A terminal may include a keyboard, a display screen, and some simple circuitry. A terminal may also include a computer.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a LAN, a WAN, and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made and that other implementations are within the scope of the following claims.

What is claimed is:

1. A computer-implemented registry system for allowing a computer user to determine the location of an information item comprising:
a record reception module to receive a record that comprises location information and one or more attributes of a stored information item and to store the record in a record repository, wherein the record is generated at a site at which the corresponding stored information item is stored;
a request management module to receive from a terminal a request for information comprising one or more attributes of a requested information item, to compare the request with records stored in the record repository, and to select one or more matching records corresponding to the one or more attributes of the request; and
a response providing module to provide to the terminal a location identifier corresponding to location information of one or more matching information items that correspond to the one or more matching records.

2. The computer-implemented registry system of claim 1, wherein the record reception module is configured to receive records without having first solicited the records.

3. The computer-implemented registry system of claim 1, further comprising a record retrieving module to retrieve records and to cause the records to be transmitted to the record reception module.

4. The computer-implemented registry system of claim 1, wherein the location identifier comprises a hyperlink for each of the matching information items.

5. The computer-implemented registry system of claim 1, wherein the terminal is located remotely from the request management module.

6. The computer-implemented registry system of claim 1, wherein the record reception module is configured to receive a copy of records stored in one or more computers located at one or more remote sites.

7. The computer-implemented registry system of claim 1, wherein the request management module is configured to transmit the request to a remote search engine and to receive one or more matching records corresponding to the one or more attributes of the request.

8. A computer-implemented retrieval system for allowing a computer user to determine the location of an information item comprising:
a request generator to generate a request having one or more attributes of a requested information item;
a request transmitting module to cause the request to be transmitted to a registry module that is configured to compare the request with records comprising location information and one or more attributes of stored information items, and to select one or more matching records that correspond to the one or more attributes of the request, wherein each record is generated at a site at which the corresponding stored information item is stored; and
a response receiving module to receive a location identifier corresponding to location information of matching information items from the registry module, wherein each matching information item corresponds to a matching record.

9. The computer-implemented retrieval system of claim 7, further comprising a record pushing module to cause records to be transmitted to the registry module without the registry module having first solicited the records.

10. The computer-implemented retrieval system of claim 7, further comprising a record gathering module to cause records to be transmitted to the registry module in response to solicitations for the records from the registry module.

11. The computer-implemented retrieval system of claim 7, wherein the location identifier comprises a hyperlink for each of the matching information items.

12. The computer-implemented retrieval system of claim 7, further comprising an information item retrieving module having:
a request module to generate an information item request to retrieve a first matching information item located at a first remote site; and
a connector to receive and decompress the first matching information item in a compressed format.

13. The computer-implemented retrieval system of claim 7, wherein the registry module is located remotely from the request transmitting module.

14. The computer-implemented retrieval system of claim 7, further comprising the registry module, wherein the registry module is configured to receive records from a local record generating module and copies of records stored in one or more computers located at one or more remote sites.

15. A computer-implemented method for providing the location of an information item to a computer user comprising:
receiving a record that comprises location information and one or more attributes of an stored information item, wherein the record is generated at a site at which the corresponding stored information item is stored;
storing the record in a record repository;
receiving from a terminal a request for information comprising one or more attributes of a requested information item;
comparing the request with records stored in the record repository;
selecting one or more matching records corresponding to the one or more attributes of the request; and
providing to the terminal a location identifier corresponding to location information of one or more matching information items that correspond to the one or more matching records.

16. The computer-implemented method of claim 14, wherein the record is received unsolicited.

17. The computer-implemented method of claim 14, wherein the record is actively retrieved.

18. The computer-implemented method of claim 14, wherein the location identifier comprises a hyperlink for each of the matching information items.

19. The computer-implemented method of claim 14, wherein the terminal from which the request is received is located at a remote site.

20. The computer-implemented method of claim 14, further comprising receiving copies of records stored in one or more computers located at one or more remote sites.

21. The computer-implemented method of claim 14, further comprising
transmitting the request to a remote search engine; and
receiving one or more matching records from the remote search engine.

22. A computer-implemented method for retrieving the location of an information item from a registry comprising:
generating a request having one or more attributes of a requested information item;
causing the request to be transmitted to a registry module that is configured to compare the request with records comprising location information and one or more attributes of stored information items, wherein each record is generated at a site at which the corresponding stored information item is stored;
selecting one or more matching records that correspond to the one or more attributes of the request; and
receiving a location identifier corresponding to location information of matching information items from the registry module, wherein each matching information item corresponds to a matching record.

23. The computer-implemented method of claim 20, further comprising causing records to be transmitted to the registry module without the registry module having first solicited the records.

24. The computer-implemented method of claim 20, further comprising causing records to be transmitted to the registry module in response to solicitations for the records from the registry module.

25. The computer-implemented method of claim 20, wherein the location identifier comprises a hyperlink for each of the matching information items.

26. The computer-implemented method of claim 20, further comprising:
generating an information item request to retrieve a first matching information item located at a first remote site;
compressing the information item request into a compressed information item request;
causing the compressed information item request to be transmitted to a connector located at the first remote site;
receiving the first matching information item in a compressed format from the connector located at the first remote site;
decompressing the first matching information item; and
providing the first matching information item to a user.

27. The computer-implemented method of claim 20, wherein the registry module is located at a remote site.

28. The computer-implemented method of claim 20, further comprising:
receiving copies of records stored in one or more computers located at one or more remote sites; and
storing the copies of records in the registry module.
